(19) United States
(12) Patent Application Publication
(10) Pub. No.: US 2023/0275290 A1
(43) Pub. Date: Aug. 31, 2023

(54) BATTERY HEAT EXCHANGE STRUCTURE

(71) Applicant: SANKEI GIKEN KOGYO CO., LTD., Tokyo (JP)

(72) Inventors: Keisuke Nakamura, Isesaki-shi (JP); Ryotaro Shimizu, Isesaki-shi (JP)

(73) Assignee: SANKEI GIKEN KOGYO CO., LTD., Tokyo (JP)

(21) Appl. No.: 18/024,204

(22) PCT Filed: Jun. 24, 2021
(86) PCT No.: PCT/JP2021/024047

§ 371 Date: Mar. 1, 2023

(30) Foreign Application Priority Data
Sep. 3, 2020 (JP) 2020-148354

(51) Int. Cl. H01M 10/659; H01M 10/6568; H01M 10/63; H01M 10/48; H01M 10/6569

(52) U.S. Cl. CPC H01M 10/659; H01M 10/6568; H01M 10/63; H01M 10/486; H01M 10/6569

(57) ABSTRACT

In this battery heat exchange structure, a heat exchange panel 42 and a battery cell 41 are closely arranged side by side so that a heat exchange wall 421 of the heat exchange panel 42 in which a heat exchange fluid circulates follows a side surface 411 of the battery cell 41, and the heat exchange wall 421 following the side surface 411 of the battery cell 41 is formed of a flexible thin plate. Preferably, a flow path wall 425 defining a flow path through which the heat exchange fluid circulates along the heat exchange wall 421 is provided in the heat exchange panel 42 so as to be able to expand and contract in an erecting direction. This battery heat exchange structure can perform heat exchange between the heat exchange panel and the battery cell with high efficiency and stably maintain high heat exchange efficiency even when the battery cell expands.

### TECHNICAL FIELD

The present invention relates to a battery heat exchange structure that exchanges heat with a battery of an electric vehicle or the like.

### BACKGROUND ART

Conventionally, as a structure for exchanging heat with an automobile battery, a structure in which a refrigerant circuit for extracting heat from the battery is provided, heat is transferred through the refrigerant, and the transferred heat is supplied to an air conditioner is known (see Patent Literatures 1 and 2).

### CITATION LIST

### Patent Literature

### [PTL 1] Japanese Patent Application Publication No. 2011-230648

### [PTL 2] Japanese Patent Application Publication No. 2015-182487

### SUMMARY OF INVENTIONS

### Technical Problem

By the way, in order to attain the purpose of extracting and collect the heat from the battery to utilize the heat efficiently as in Patent Literatures 1 and 2, it is important to install a heat exchange structure having high heat exchange efficiency in the battery. In addition, in a battery, thermal expansion of the battery cell occurs at high temperatures, and expansion of the battery cell also occurs due to deterioration. Thus, there is a demand for a structure capable of stably maintaining high heat exchange efficiency even when such expansion of the battery cell occurs.

The present invention is proposed in view of the above problems, and an object thereof is to provide a battery heat exchange structure capable of performing heat exchange between a heat exchange panel and a battery cell with high efficiency and stably maintaining high heat exchange efficiency even when the battery cell expands.

### Solution to Problem

In a battery heat exchange structure of the present invention, a heat exchange panel and a battery cell are closely arranged side by side so that a heat exchange wall of the heat exchange panel in which a heat exchange fluid circulates follows a side surface of the battery cell, and the heat exchange wall following the side surface of the battery cell is formed of a flexible thin plate.

According to this configuration, the heat exchange wall of the heat exchange panel in which the heat exchange fluid circulates is in close contact with and follows the side surface of the battery cell. Thus, heat exchange between the heat exchange panel and the battery cell can be performed efficiently. In addition, since the heat exchange wall is formed of the flexible thin plate, when expansion of the battery cell occurs due to thermal expansion or deterioration, the flexible thin plate of the heat exchange wall follows the expansion and a satisfactory close-contact state between the heat exchange wall and the side surface of the battery cell can be maintained. Therefore, high heat exchange efficiency can be stably maintained even when expansion of the battery cell occurs.

In the battery heat exchange structure of the present invention, a flow path wall defining a flow path through which the heat exchange fluid circulates along the heat exchange wall is provided in the heat exchange panel, and the flow path wall is provided so as to be able to expand and contract in an erecting direction.

According to this configuration, even when a structure in which the heat exchange fluid circulates along the flow path wall and the heat exchange wall in the heat exchange panel is adopted, since the flow path wall can be expanded and contracted in the erecting direction, when expansion of the battery cell occurs due to thermal expansion or deterioration, it is possible to follow the expansion due to the flexibility in the erecting direction of the flow path wall and the flexible thin plate of the heat exchange wall. Therefore, a satisfactory close-contact state between the heat exchange wall and the side surface of the battery cell can be maintained, and high heat exchange efficiency can be stably maintained even when expansion of the battery cell occurs.

In the battery heat exchange structure of the present invention, the heat exchange fluid is a refrigerant, and an elastic storage portion forming the flow path wall is filled with a latent heat storage material that undergoes a phase change at a temperature lower than the temperature of the refrigerant when the refrigerant is supplied.

According to this configuration, at low temperatures the battery cell, excessive temperature drops in the battery cell can be suppressed by exchanging heat with the heat released by the phase change of the latent heat storage material, and a temporary decrease in battery performance due to a decrease in output voltage and a decrease in discharge capacity can be prevented. In addition, at high temperatures of the battery cell, excessive temperature rise in the battery cell can be suppressed by exchanging heat with the refrigerant circulating through the heat exchange panel, and permanent deterioration of battery performance and shortening of battery life can be prevented.

In the battery heat exchange structure of the present invention, the flow path has three or more branch flow paths, each of the branch flow paths is provided so as to circulate the refrigerant along the heat exchange wall, and the latent heat storage material is provided at least between the branch flow paths.

According to this configuration, with respect to the heat exchange wall of the heat exchange panel, for example, the region corresponding to the arrangement of the latent heat storage material, such as a latent heat storage material having a lower thermal conductivity than the refrigerant, can be more evenly distributed, and the region corresponding to the circulation of the refrigerant can be more evenly distributed. Furthermore, the heat exchange that suppresses an excessive temperature drop at low temperatures and the heat exchange that suppresses an excessive temperature rise at high temperatures can be performed more reliably. Therefore, the temperature of the battery can be reliably controlled to be within an appropriate temperature range. In addition, since the latent heat storage material is arranged in a wide range or in a plurality of region with a more even distribution, even when a latent heat storage material with poor thermal conductivity is used, the capacity of the latent heat storage material can be maximized.

In the battery heat exchange structure of the present invention, the heat exchange panel and the battery cell are elastically urged so as to be compressed in the arrangement direction.

According to this configuration, since the heat exchange panel and the battery cell are elastically urged so as to be compressed and pressed in the arrangement direction, the heat exchange efficiency between the heat exchange panel and the battery cell can be further improved, and the stability of heat exchange can be enhanced. In addition, it is possible to stably secure a state in which the heat exchange panel and the battery cell are in a close-contact with each other in the arrangement direction following the expansion of the battery and the contraction when the temperature drops. In addition, due to the heat exchange panel and the battery cell being elastically urged in the arrangement direction, and the followability of the flexible thin plate of the heat exchange wall, it is possible to absorb the amount of expansion during expansion such as thermal expansion of the battery cell, prevent damage to the heat exchange structure due to an increase in internal pressure, and improve safety.

In the battery heat exchange structure of the present invention, a battery body including the battery cell and the heat exchange panel, and a support portion supporting the battery body are housed in an insulating container.

According to this configuration, since the battery body is housed in the insulating container, the influence of the temperature of the external environment on the battery can be reduced, and the range of the low temperature level that can be handled in a low-temperature external environment and the range of the high temperature level that can be handled in a high-temperature external environment can be extended. Furthermore, the temperature range in which the temperature of the battery can be controlled to be within an appropriate temperature range can be extended. In addition, when the battery body is equipped with a protection circuit that regulates the output at a very high temperature, it is possible to prevent the protection circuit from operating unexpectedly at a very high temperature in the summer.

In the battery heat exchange structure of the present invention, the heat exchange fluid is a refrigerant, a temperature sensor for detecting a temperature of the battery cell is provided close to the battery cell, and a refrigerant control unit supplies the refrigerant having a required temperature to the heat exchange panel according to a detection temperature from the temperature sensor.

According to this configuration, the refrigerant having a required temperature can be circulated as necessary according to the detection temperature from the temperature sensor, and the temperature of the battery can be automatically controlled to be in an appropriate temperature range by lowering the temperature of the battery.

### ADVANTAGEOUS EFFECTS OF INVENTION

According to the battery heat exchange structure of the present invention, it is possible to perform heat exchange between a heat exchange panel and a battery cell with high efficiency and stably maintain high heat exchange efficiency even when the battery cell expands.

### BRIEF DESCRIPTION OF DRAWINGS

FIG. 1 is a plan view of a battery insulation structure according to an embodiment of the present invention.

FIG. 2 is an enlarged cross-sectional view taken along the line A-A in FIG. 1.

FIG. 3 is an enlarged view of the part B-B in FIG. 2.

FIG. 4 is an enlarged view of the part C in FIG. 3.

FIG. 5 is a longitudinal explanatory view of a heat exchange panel in the battery heat exchange structure of the embodiment.

FIG. 6 is an enlarged cross-sectional explanatory view of a heat exchange panel in the battery heat exchange structure of the embodiment.

FIG. 7 is a block diagram showing a battery heat exchange structure and a refrigerant control configuration according to the embodiment.

FIG. 8 is a perspective explanatory view of a heat exchange panel in a battery heat exchange structure according to a modification of the embodiment.

### DESCRIPTION OF EMBODIMENTS

### Battery Heat Exchange Structure of Embodiment

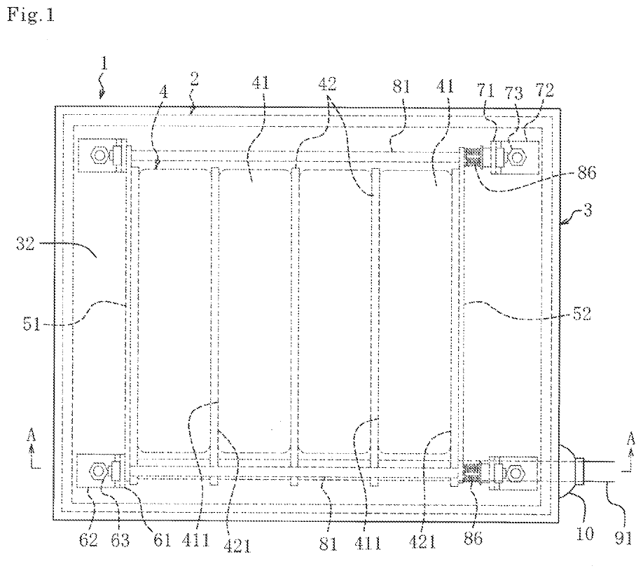

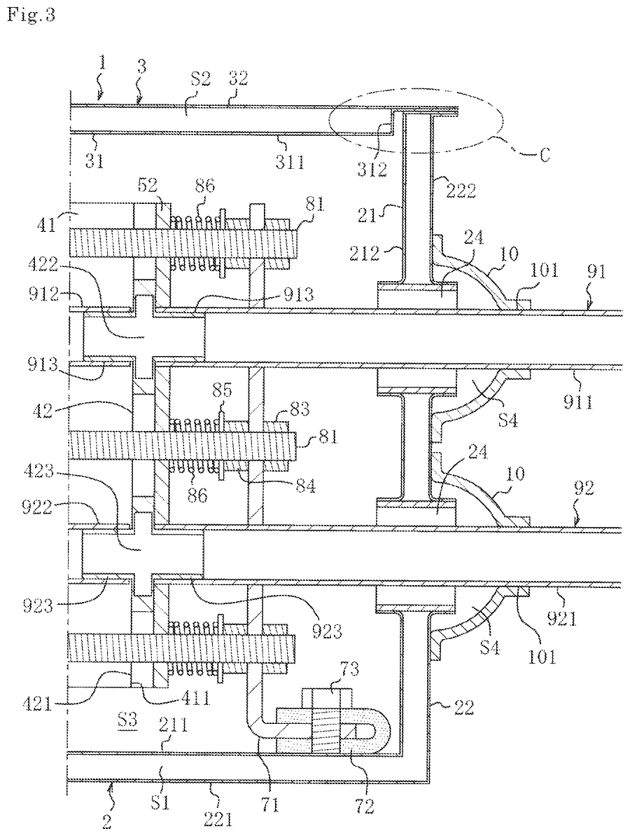

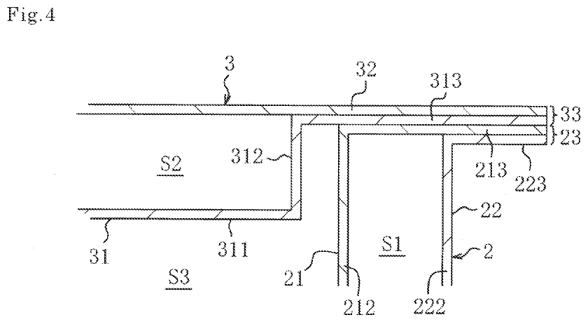

As shown in FIGS. 1 to 4, the battery heat exchange structure of an embodiment according to the present invention includes a double-walled insulating container 1 composed of an insulating container main body 2 and an insulating lid 3, and a battery body 4 housed in the insulating container 1. In the battery body 4, as will be described later, heat exchange is performed between a battery cell 41 and a latent heat storage material 427 in a heat exchange panel 42, and between the battery cell 41 and the refrigerant F corresponding to a heat exchange fluid flowing through the heat exchange panel 42.

The insulating container main body 2 is formed in a substantially rectangular box shape with an open upper surface, and has a double-wall structure including a substantially rectangular box-shaped inner wall 21 with an open upper surface and a substantially rectangular box-shaped outer wall 22 with an open upper surface. A bottom portion 211 of the inner wall 21 and a bottom portion 221 of the outer wall 22, and a peripheral side portion 212 of the inner wall 21 and a peripheral side portion 222 of the outer wall 22 are arranged to be spaced apart from each other, and an insulating space S1 is provided between the inner wall 21 and the outer wall 22. The insulating space S1 is preferably a vacuumed decompression space, but it can also be an air layer, and the insulating space S1 of the present embodiment is hollow but a solid insulating material may be filled in the insulating space S1.

A flat flange 213 protruding outward is formed at the upper end of the peripheral side portion 212 of the inner wall 21, and a flat flange 223 protruding outward is formed at the upper end of the peripheral side portion 22 of the outer wall 22. The flange 213 is overlapped so as to be placed on the flange 223, the ends of the inner wall 21 and the outer wall 22 are sealed, and the flanges are fixed by welding or the like at the overlapping position, whereby a container-side flat flange 23 is formed.

The insulating lid 3 is formed in a substantially flat plate shape, and has a double-wall structure including a thin dish-shaped inner lid 31 whose center is recessed from the peripheral edge and a flat plate-shaped outer lid 32. The inner lid 31 has a substrate 311 and an erected portion 312 that stands around the substrate 311 and a flange 313 that protrudes outward from the upper end of the erected portion 312. The substrate 311 of the inner lid 31 and the outer lid 32 are arranged to be spaced apart from each other, and an insulating space S2 is provided between the substrate 311 of the inner lid 31 and the outer lid 32, in other words, between the inner lid 31 and the outer lid 32. The insulating space S2 is also preferably a vacuumed decompression space, but it can also be an air layer, and the insulating space S2 of the present embodiment is hollow but a solid insulating material may be filled in the insulating space S2.

The outer lid 32 is overlapped so as to be placed on the flange 313 of the inner lid 31. The ends of the inner lid 31 and the outer lid 32 are sealed, and the lids are fixed by welding or the like at the position where the outer lid 32 is overlapped with the flange 313 of the inner lid 31, whereby a lid-side flat flange 33 is formed.

The insulating container 1 is closed in such a way that a lower surface of the lid-side flat flange 33 of the insulating lid 3 having a planar area equal to or larger than the container-side flat flange 23 is overlapped so as to be placed on an upper surface of the container-side flat flange 23 having a planar area larger than the planar area at the upper end position of the insulating space S1 of the insulating container main body 2 and the insulating lid 3 engages with the insulating container main body 2. The container-side flat flange 23 and the lid-side flat flange 33, which are overlapped in a state where the planar contact area is larger than the planar area at the upper end position of the insulating space S1, are detachably fixed by fixing members such as bolts and nuts (not shown).

By closing the insulating container 1 by increasing the mutual contact area at the contact position of the insulating container main body 2 and the insulating lid 3, the airtightness, the sealing property, and the insulating property at the contact position between the insulating container main body 2 and the insulating lid 3 can be improved. It is also preferable to provide a sealing material between the container-side flat flange 23 and the lid-side flat flange 33, and to place the lid-side flat flange 33 on the container-side flat flange 23 via the sealing material interposed therebetween.

The outer peripheral dimensions of the substrate 311 and the erected portion 312 of the inner lid 31 of the insulating lid 3 are formed to be slightly smaller than the inner peripheral dimension at the upper end position of the inner wall 21 of the insulating container main body 2. In the closed state of the insulating container 1, the substrate 311 and the erected portion 312 of the inner lid 31 of the insulating lid 3 are tightly or loosely fitted inside the inner wall 21 of the insulating container main body 2, and the insulating lid 3 engages with the insulating container main body 2.

The battery body 4 of the present embodiment has a plurality of battery cells 41 provided side by side at predetermined intervals, and heat exchange panels 42 provided on both sides of each battery cell 41 in the arrangement direction. The battery body 4 has a stacked structure in which the battery cell 41 and the heat exchange panel 42 are closely and alternately stacked. In the battery body 4, the battery cell 41 and the heat exchange panel 42 are closely and alternately arranged side by side so that the heat exchange wall 421 of the heat exchange panel 42 follows the side surface 411 of the battery cell 41. The heat exchange wall 421 of the heat exchange panel 42 is formed of a flexible thin plate, and is preferably formed in a thickness of 0.5 mm or less using a metal material such as stainless steel or aluminum, for example.

Holding plates 51 and 52 are provided on the outer sides of the heat exchange panels 42 and 42 located at both ends in the arrangement direction of the battery cell 41 and the heat exchange panel 42 of the battery body 4. In other words, the battery cell 41 and the heat exchange panel 42 are closely and alternately arranged side by side between one holding plate 51 provided at one end in the arrangement direction of the battery cell 41 and the heat exchange panel 42 and the other holding plate 52 provided at the other end. The battery cell 41 and the heat exchange panel 42 are installed in the insulating container 1 so as to be sandwiched between the holding plates 51 and 52.

A side portion of a substantially L-shaped support stay 61 is arranged adjacent to the outer side of the holding plate 51 on one side in the arrangement direction of the battery cell 41 and the heat exchange panel 42, and the lower portion of the support stay 61 is engaged with an insulating material 62 such as an insulating rubber having a substantially U-shaped cross-section fixed to the bottom portion 211 of the inner wall 21 of the insulating container main body 2 and is fixed to the insulating material 62 by fastening a bolt 63. That is, the battery body 4 sandwiched between the holding plates 51 and 52 is installed with the insulating material 62 fixed to the inner wall 21 of the insulating container main body 2 interposed therebetween. The support stay 61, the insulating material 62, and the bolt 63 are arranged near both ends of the holding plate 51 on one side in a direction orthogonal to the arrangement direction of the battery cell 41 and the heat exchange panel 42 in the plan view of the insulating container 1.

A side portions of a substantially L-shaped support stay 71 is arranged at an interval from the holding plate 52 on the outer side of the holding plate 52 on the other side in the arrangement direction of the battery cell 41 and the heat exchange panel 42, and the lower portion of the support stay 71 is also engaged with an insulating material 72 such as an insulating rubber having a substantially U-shaped cross-section fixed to the bottom portion 211 of the inner wall 21 of the insulating container main body 2 and is fixed to the insulating material 72 by fastening a bolt 73. That is, the battery body 4 sandwiched between the holding plates 51 and 52 is installed with the insulating material 72 fixed to the inner wall 21 of the insulating container main body 2 interposed therebetween. The support stay 71, the insulating material 72, and the bolt 73 are arranged at positions corresponding to both ends of the holding plate 52 on the other side in a direction orthogonal to the arrangement direction of the battery cell 41 and the heat exchange panel 42 in the plan view of the insulating container 1.

A shaft bolt 81 is provided so as to penetrate the support stay 61, the holding plate 51, the holding plate 52, and the support stay 71. The shaft bolts 81 are provided on both sides of a direction orthogonal to the arrangement direction of the battery cell 41 and the heat exchange panel 42. In the shown example, the shaft bolts 81 are provided at three locations in the vertical direction, and a total of six shaft bolts 81 are provided. A nut 82 is screwed into the shaft bolt 81 in close contact with the support stay 61 on the outer side of the support stay 61, a nut 83 is screwed in close contact with the support stay 71 on the outer side of the support stay 71, and a nut 84 is screwed in close contact with the support stay 71 on the inner side of the support stay 71. A washer 85 is arranged on the holding plate 52 side of the nut 84.

A coil spring 86 is provided as an elastic material between the washer 85 and the holding plate 52, and the coil spring 86 is externally inserted to the outer periphery of the shaft bolt 81. The coil spring 86 presses and urges the holding plate 52 toward the holding plate 51 by elastic restoration, whereby the battery body 4 in which the battery cell 41 and the heat exchange panel 42 are closely and alternately stacked is sandwiched between the holding plate 51 and the holding plate 52 by the urging force. In other words, the heat exchange panel 42 and the battery cell 41 are provided so as to be elastically urged to be compressed in the arrangement direction.

A plurality of coil springs 86 in the present embodiment are provided so as to correspond to positions corresponding to the vicinities of the four corners of the substantially rectangular holding plates 51 and 52 and the substantially rectangular heat exchange panel 42 provided to be overlapped so as to correspond to the positions of the four corners thereof and substantially intermediate positions of the positions corresponding to the vicinities of the four corners. The coil springs 86 are arranged at well-balanced intervals with respect to the heat exchange wall 421 of the heat exchange panel 42. The battery cells 41 and the heat exchange panel 42 arranged side by side are urged by the plurality of coil springs 86 arranged at well-balanced intervals, and the compressive force is applied substantially uniformly to the heat exchange wall 421 of the heat exchange panel 42. The coil spring 86 also has a function of absorbing the expansion amount due to the thermal expansion by contraction deformation while maintaining the sandwiching state of the battery body 4 when the battery cell 41 thermally expands due to heat generation.

In the present embodiment, the elastic coil spring 86 is provided on the outer side of the other holding plate 52 as the outer side of one holding plate to urge the battery cell 41 and the heat exchange panel 42 arranged side by side. However, the elastic coil spring 86 may be provided on the outer side of one holding plate 51 on the opposite side to urge the battery cell 41 and the heat exchange panel 42 arranged side by side. Alternatively, the elastic coil spring 86 may be provided on both outer sides of both holding plates 51 and 52 to urge the battery cell 41 and the heat exchange panel 42 arranged side by side. In addition, as the elastic material for urging the battery cell 41 and the heat exchange panel 42 arranged side by side, a spring, a rubber material, or the like other than the coil spring 86 can be appropriately used.

The battery body 4 composed of the battery cell 41 and the heat exchange panel 42, the holding plates 51 and 52 corresponding to the support portion for supporting the battery body 4, the support stays 61 and 71, the insulating materials 62 and 72, the bolts 63 and 73, the shaft bolt 81, the nuts 82, 83, and 84, the washer 85, and the coil spring 86 are housed in the insulating container 1. The battery body 4 supported by the urging of the coil spring 86 and the sandwiching of the holding plates 51 and 52 is arranged to be spaced apart from the inner wall 21 of the insulating container main body 2 and the inner lid 31 of the insulating lid 3, and an insulating space S3 is also formed inside the insulating container 1.

In the battery heat exchange structure of the present embodiment, a fluid supply pipe 91 for supplying the refrigerant F corresponding to the heat exchange fluid to the heat exchange panel 42 and a fluid discharge pipe 92 for discharging the refrigerant F corresponding to the heat exchange fluid from the heat exchange panel 42 are provided so as to penetrate the inner wall 21 and the outer wall 22 of the insulating container main body 2. The portion of the fluid supply pipe 91 arranged in the insulating container 1 corresponding to a portion of the fluid supply pipe 91 and the portion of the fluid discharge pipe 92 arranged in the insulating container 1 corresponding to a portion of the fluid discharge pipe 92 are arranged so as to follow the arrangement direction of the battery cell 41 and the heat exchange panel 42 and are provided in parallel to the arrangement direction.

The fluid supply pipe 91 includes a fluid introduction pipe 911, a connecting pipe 912 composed of an elastic tube such as a rubber pipe that can be elastically restored and stretched, and a protruding pipe 913 that protrudes in the panel normal direction from the inlet port of the heat exchange panel 42. The fluid introduction pipe 911 is composed of an elastic tube such as a rubber pipe that can be elastically restored and stretched, and is externally inserted and attached to the protruding pipe 913 of the heat exchange panel 42 that is arranged at the nearest position. The protruding pipes 913 and 913 of the heat exchange panels 42 and 42 arranged side by side are connected to each other via the connecting pipe 912, and both ends of the connecting pipe 912 are externally inserted and attached to the protruding pipe 913. That is, the portion of the fluid supply pipe 91 between the heat exchange panels 42 and 42 is configured by the elastic connecting pipe 912. The connecting pipe 912 composed of an elastic tube elastically expands to follow thermal expansion when the battery cell 41 thermally expands due to heat generation, and elastically restores according to the convergence of the thermal expansion to be adaptable to the thermal expansion.

The fluid discharge pipe 92 includes a fluid lead-out pipe 921, a connecting pipe 922 composed of an elastic tube such as a rubber pipe that can be elastically restored and stretched, and a protruding pipe 923 that protrudes in the panel normal direction from the outlet port of the heat exchange panel 42. The fluid lead-out pipe 921 is also composed of an elastic tube such as a rubber pipe that can be elastically restored and stretched, and is externally inserted and attached to the protruding pipe 923 of the heat exchange panel 42 that is arranged at the nearest position. The protruding pipes 923 and 923 of the heat exchange panels 42 and 42 arranged side by side are connected to each other via the connecting pipe 922, and both ends of the connecting pipe 922 are externally inserted and attached to the protruding pipe 923. That is, the portion of the fluid discharge pipe 92 between the heat exchange panels 42 and 42 is configured by the elastic connecting pipe 922. The connecting pipe 922 composed of an elastic tube elastically expands to follow thermal expansion when the battery cell 41 thermally expands due to heat generation, and elastically restores according to the convergence of the thermal expansion to be adaptable to the thermal expansion.

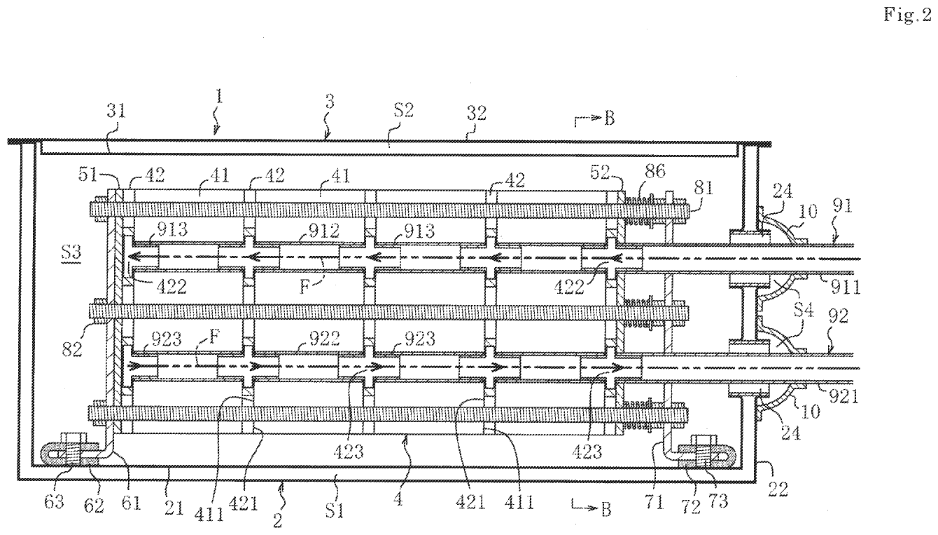

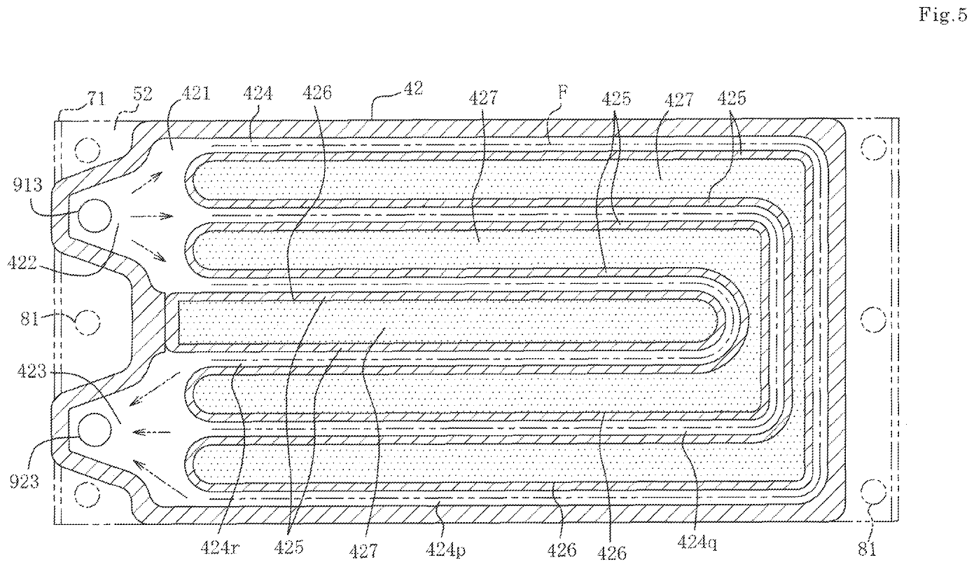

As shown in FIGS. 2 and 5, the refrigerant F corresponding to a heat exchange fluid such as cooling water supplied by the fluid supply pipe 91 is distributed by flowing into the respective heat exchange panels 42 from the inlet port 422 communicating with the protruding pipe 913. The refrigerant F circulates in the heat exchange panel 42 along the heat exchange wall 421, and is discharged to the outside through the fluid discharge pipe 92 so as to be collected in the fluid discharge pipe 92 from the outlet port 423 communicating with the protruding pipes 923 of the respective heat exchange panels 42. When the heat exchange panel 42 is, for example, a thin panel having a thickness of 4 mm or less, the installation space can be satisfactorily saved.

A flow path 424 through which the refrigerant F corresponding to the heat exchange fluid circulates along the heat exchange wall 421 is provided in the heat exchange panel 42, and the flow path 424 is defined by flow path walls 425. In the example of FIG. 5, three branch flow path 424p, 242q, and 424r are formed in the flow path 424, and the branch flow paths 424p, 424q, and 424r circulate the refrigerant F corresponding to a heat exchange fluid along the heat exchange wall 421. The flow path 424 or the branch flow paths 424p, 424q, and 424r allow the refrigerant F to circulate along the heat exchange wall 421 over substantially the entire heat exchange wall 421.

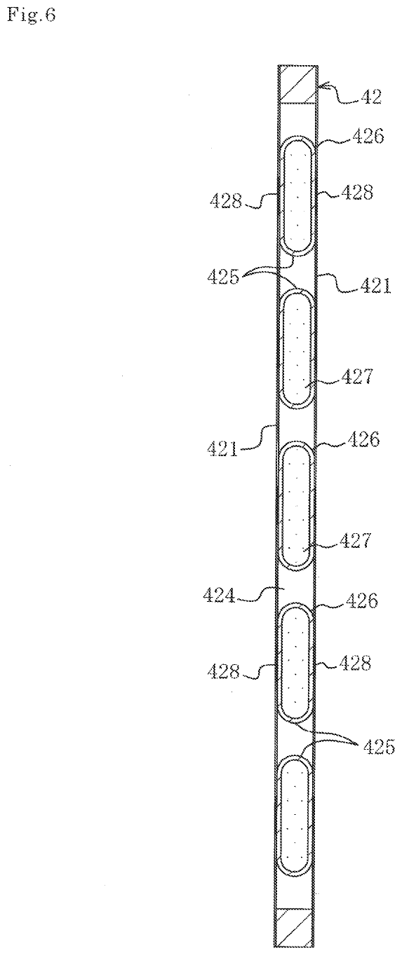

The flow path wall 425 of the present embodiment is composed of a part of a closed elongated bag-like elastic storage portion 426, and is configured to be able to expand and contract in the erecting direction of the flow path wall 425, that is, in the direction in which the heat exchange walls 421 of the heat exchange panel 42 face each other. The elastic storage portion 426 is formed of a material having excellent thermal conductivity and is capable of expanding and contracting in the erecting direction of the flow path wall 425. The elastic storage portion 426 is preferably formed of a metal material such as aluminum or stainless steel formed such that the thickness of a portion corresponding to at least the flow path wall 425 is 0.5 mm or less, or a resin material having excellent elasticity and thermal conductivity, such as a rubber material in which a thermal conductive filler is dispersed. The closed elongated bag-like elastic storage portion 426 is placed at a predetermined position and fixed to the heat exchange wall 421 with a fixing portion 428 such as adhesive (see FIG. 6).

Instead of a structure in which the closed elongated bag-like elastic storage portion 426 formed a part of the flow path wall 425, a bellows-shaped flow path wall that can expand and contract in the erecting direction of the flow path wall may be formed, a space surrounded by the flow path wall and the heat exchange wall 421 may form an elastic storage portion, and the latent heat storage material 427, which will be described later, may be housed in the elastic storage portion.

The elastic storage portion 426 forming the flow path wall 425 is filled with the latent heat storage material 427 that undergoes a phase change (phase transition) at a temperature lower than the temperature of the refrigerant F when the refrigerant is supplied. In the example of FIG. 5, two elastic storage portions 426 substantially U-shaped in plan view of the heat exchange panel 42 are provided. Furthermore, an elastic storage portion 426 is formed near the in-course of the refrigerant circulation and an elastic storage portion 426 is formed near the out-course of the refrigerant circulation. In addition, one substantially rectangular elastic storage portion 426 is provided so as to extend horizontally from the side of the inlet port 422 and the outlet port 423 to form a central partition wall, and the elastic storage portions 426 are filled with the latent heat storage material 427.

In other words, in this example, the elastic storage portion 426 filled with the latent heat storage material 427 is provided between the branch flow path 424p and the branch flow path 424q and between the branch flow path 424q and the branch flow path 424r. In addition, the elastic storage portion 426 filled with the latent heat storage material 427 is provided in the central partition wall configured to circulate the refrigerant F. Each elastic storage portion 426 is surrounded and partitioned by the flow path wall 425 over the entire circumference, and is sealed. As the refrigerant F, an applicable low-temperature liquid or gas can be used. For example, it is preferable to use cooling water or the like. An appropriate latent heat storage material that undergoes a phase change (phase transition) at a temperature lower than the temperature of the refrigerant F when the refrigerant is supplied can be used as the latent heat storage material 427. For example, a paraffin-based latent heat storage material that undergoes a phase change at a specific temperature within the temperature range of 5° C. to 20° C. is preferably used.

The insulating container main body 2 is provided with a plurality of penetrating portions 24 formed by fixing a short cylinder or the like so as to maintain a closed state of the insulating space S1 between the inner wall 21 and the outer wall 22. The fluid supply pipe 91 and the fluid introduction pipe 911 are provided so as to penetrate the penetrating portions 24. In this way, the fluid supply pipe 91 and the fluid discharge pipe 92 are connected to the inside and outside of the insulating container 1 through the penetrating portion 24.

Around the penetrating portion 24, a substantially concave cap 10 is fixed to the outer surface of the insulating container 1 with the concave side facing the outer surface of the insulating container 1. In the present embodiment, the cap 10 is fixed by welding or the like to the outer surface of the outer wall 22 of the insulating container main body 2. An insertion hole 101 is formed substantially in the center of the cap 10, and the fluid introduction pipe 911 or the fluid lead-out pipe 921 is inserted into the insertion hole 101. An insulating space S4 surrounded by the cap 10, the outer surface of the outer wall 22, and the outer surface of the fluid introduction pipe 911 or the fluid lead-out pipe 921 is provided on the concave side of the substantially concave cap 10 (in the shown example, the bowl-shaped cap 10).

According to the battery heat exchange structure of the present embodiment, the heat exchange wall 421 of the heat exchange panel 42 in which the refrigerant F corresponding to the heat exchange fluid circulates is in close contact with and follows the side surface 411 of the battery cell 41. Thus, heat exchange between the heat exchange panel 42 and the battery cell 41 can be performed efficiently. In addition, since the heat exchange wall 421 is formed of the flexible thin plate, when expansion of the battery cell 41 occurs due to thermal expansion or deterioration, the flexible thin plate of the heat exchange wall 421 follows the expansion and a satisfactory close-contact state between the heat exchange wall 421 and the side surface 411 of the battery cell 41 can be maintained. Therefore, high heat exchange efficiency can be stably maintained even when expansion of the battery cell 41 occurs.

In addition, even when a structure in which the refrigerant F corresponding to the heat exchange fluid circulates along the flow path wall 425 and the heat exchange wall 421 in the heat exchange panel 42 is adopted, since the flow path wall 425 can be expanded and contracted in the erecting direction, when expansion of the battery cell 41 occurs due to thermal expansion or deterioration, it is possible to follow the expansion due to the flexibility in the erecting direction of the flow path wall 425 and the flexible thin plate of the heat exchange wall 421. Therefore, a satisfactory close-contact state between the heat exchange wall 421 and the side surface 411 of the battery cell 41 can be maintained, and high heat exchange efficiency can be stably maintained even when expansion of the battery cell 41 occurs.

In addition, the elastic storage portion 426 forming the flow path wall 425 is filled with the latent heat storage material 427 that undergoes a phase change at a temperature lower than the temperature of the refrigerant F when the refrigerant is supplied. Therefore, at low temperatures of the battery cell 41, excessive temperature drops in the battery cell 41 can be suppressed by exchanging heat with the heat released by the phase change of the latent heat storage material 427, and a temporary decrease in battery performance due to a decrease in output voltage and a decrease in discharge capacity can be prevented. In addition, at high temperatures of the battery cell 41, excessive temperature rise in the battery cell 41 can be suppressed by exchanging heat with the refrigerant F circulating through the heat exchange panel 42, and permanent deterioration of battery performance and shortening of battery life can be prevented.

Further, the flow path 424 has three or more branch flow paths 424p, 424q, and 424r, each of the branch flow paths 424p, 424q, and 424r is provided so as to circulate the refrigerant F along the heat exchange wall 421, and the elastic storage portions 426 filled with the latent heat storage material 427 are provided at least between the branch flow paths. Therefore, with respect to the heat exchange wall 421 of the heat exchange panel 42, for example, the region corresponding to the arrangement of the latent heat storage material 427, such as a latent heat storage material having a lower thermal conductivity than the refrigerant, can be more evenly distributed, and the region corresponding to the circulation of the refrigerant F can be more evenly distributed. Furthermore, the heat exchange that suppresses an excessive temperature drop at low temperatures and the heat exchange that suppresses an excessive temperature rise at high temperatures can be performed more reliably. Therefore, the temperature of the battery can be reliably controlled to be within an appropriate temperature range. In addition, since the latent heat storage material 427 is arranged in a wide range or in a plurality of region with a more even distribution, even when a latent heat storage material with poor thermal conductivity is used, the capacity of the latent heat storage material can be maximized.

Further, since the heat exchange panel 42 and the battery cell 41 are elastically urged so as to be compressed and pressed in the arrangement direction, the heat exchange efficiency between the heat exchange panel 42 and the battery cell 41 can be further improved, and the stability of heat exchange can be enhanced. In addition, it is possible to stably secure a state in which the heat exchange panel 42 and the battery cell 41 are in a close-contact with each other in the arrangement direction following the expansion of the battery and the contraction when the temperature drops. In addition, due to the heat exchange panel 42 and the battery cell 41 being elastically urged in the arrangement direction, and the followability of the flexible thin plate of the heat exchange wall 421, it is possible to absorb the amount of expansion during expansion such as thermal expansion of the battery cell 41, prevent damage to the heat exchange structure due to an increase in internal pressure, and improve safety.

The heat exchange surface 421 of the heat exchange panel 42 can be pressed substantially uniformly against the side surface 411 of the battery cell 41 via the holding plates 51 and 52 by the urging of the coil spring 86, the heat exchange efficiency between the battery cell 41 and the refrigerant F of the heat exchange panel 42 can be further improved, and the stability of heat exchange can be further improved.

Since a portion of the fluid supply pipe 91 and a portion of the fluid discharge pipe 92 are provided so as to follow the arrangement direction of the battery cell 41 and the heat exchange panel 42, by providing only parts and components that branch the fluid supply pipe 91 and the fluid discharge pipe 92 corresponding to the main pipe, the refrigerant F can flow into the plurality of heat exchange panels 42 and the refrigerant F can flow out from the plurality of heat exchange panels 42. Thus, it is possible to reduce the number of members, reduce the manufacturing cost, and improve the efficiency of the assembly process.

Due to the elastic connecting pipe 912 corresponding to the part of the fluid supply pipe 91 between the heat exchange panels 42 and 42 and the elastic connecting pipe 922 corresponding to the part of the fluid discharge pipe 92 between the heat exchange panels 42 and 42, the elastic tube expands to follow when the battery cell 41 thermally expands due to heat generation, and elastically restores according to the convergence of the thermal expansion, and the thermal expansion can be absorbed by the fluid supply pipe 91 and the fluid discharge pipe 92.

Since the battery body 4 including the battery cell 41 and the heat exchange panel 42 and the support portion for supporting the battery body 4 are housed in the insulating container 1, the influence of the temperature of the external environment on the battery can be reduced. The range of the low temperature level that can be handled in a low-temperature external environment and the range of the high temperature level that can be handled in a high-temperature external environment can be extended. Therefore, the temperature range in which the temperature of the battery can be controlled to be within an appropriate temperature range can be extended. In addition, when the battery body is equipped with a protection circuit that regulates the output at a very high temperature, it is possible to prevent the protection circuit from operating unexpectedly at a very high temperature in the summer. In particular, in the present embodiment, since the insulating spaces S1 and S2 are provided in the insulating container 1 and the battery body 4 is housed in the insulating container 1 so as to be spaced apart from the insulating container 1, these effects can be further enhanced.

In addition, when the temperature of the battery cell 41 in a low temperature state is raised to an appropriate temperature range, since the temperature can be raised without using the heating of the heater that uses the electric power of the battery, it is possible to prevent a decrease in the cruising distance of an automobile, for example. The heat collected via the refrigerant F by the heat exchange between the high-temperature battery cell 41 and the refrigerant F can be supplied to the battery or other places where heat is needed when necessary by a heat storage device or the like separately provided.

### Scope of Inclusion of Invention Disclosed in Present Specification

The invention disclosed in the present specification includes, in addition to the inventions listed as inventions and embodiments, those specified by changing the partial contents thereof to other contents disclosed in the present specification to an applicable extent, those specified by adding other contents disclosed in the present specification to these contents, or those specified by deleting these partial contents to the extent that a partial action and effect can be obtained and making them into a higher concept. The invention disclosed in the present specification also includes the following modifications and additional contents.

For example, the insulating container in which the battery cell and the heat exchange panel of the present invention are housed is preferably the insulating container 1 of the above-described embodiment, but they can also be housed in an insulating container other than the insulating container 1 of the above-described embodiment. The shape and number of penetrating portions 24 provided in the double wall of the insulating container 1 with the insulating spaces 51 and S2 closed may be changed appropriately. For example, the penetrating portion 24 through which the battery cable is passed, the penetrating portion 24 through which the fluid supply pipe 91 is passed, and the penetrating portion 24 through which the fluid discharge pipe 92 is passed may be provided individually. Alternatively, both the battery cable and the fluid supply pipe 91 or the fluid discharge pipe 92 may be passed through one penetrating portion 24.

In addition, the battery heat exchange structure of the present invention includes an appropriate configuration including a configuration in which a heat exchange panel and a battery cell are closely arranged side by side so that a heat exchange wall of the heat exchange panel in which a heat exchange fluid circulates follows a side surface of the battery cell, and the heat exchange wall following the side surface of the battery cell is formed of a flexible thin plate. For example, the present invention also includes a configuration in which the battery cell and the heat exchange panel are not housed in the insulating container. Moreover, for example, the present invention also includes a configuration in which a heat exchange wall of a single heat exchange panel and a side surface of a single battery cell are closely arranged side by side. The present invention also includes a configuration in which the battery cell and the heat exchange panel are closely arranged side by side so that the heat exchange wall of the heat exchange panel follows the side surface of one or both battery cells at every other location between the battery cells. The present invention also includes a configuration in which the battery cell and the heat exchange panel are closely arranged side by side so that the heat exchange wall of the heat exchange panel follows the side surface of one or both battery cells at a small number of locations such as two or three locations smaller than the locations between the plurality of battery cells such as one, two, or three locations among all locations between the plurality of battery cells. Further, the heat exchange fluid of the present invention is not limited to the refrigerant F, and includes any suitable fluid capable of exchanging heat with the battery cell.

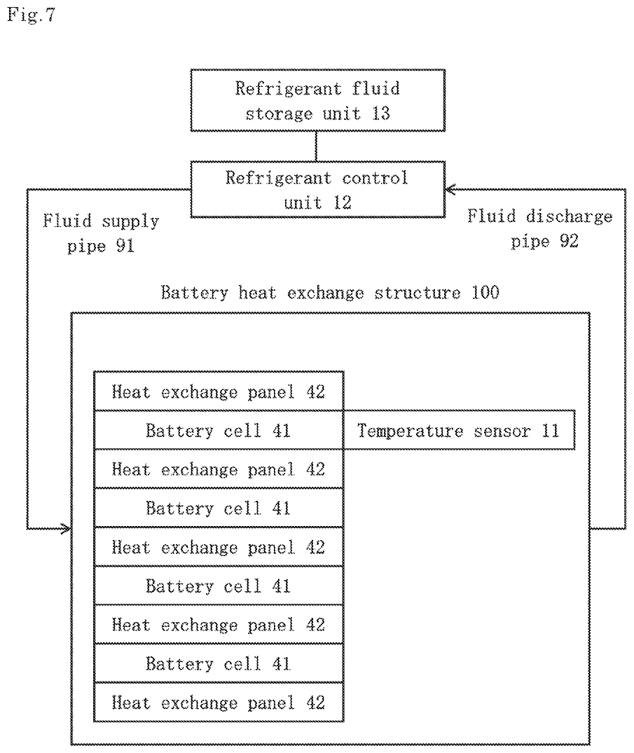

In the battery heat exchange structure of the present invention, as shown in FIG. 7, it may be preferable that a temperature sensor 11 for detecting the temperature of the battery cell 41 of the battery heat exchange structure 100 is provided close to the battery cell 41, and a refrigerant control unit 12 supplies the refrigerant F having a required temperature of a refrigerant storage unit 13 according to the detection temperature from the temperature sensor 11. In this way, the refrigerant F having a required temperature can be circulated as necessary according to the detection temperature from the temperature sensor 11, and the temperature of the battery can be automatically controlled to be in an appropriate temperature range. The communication between the refrigerant control unit 12 and the temperature sensor 11 can be performed by wired communication using a cable provided through the penetrating portion 24 or the like or wireless communication.

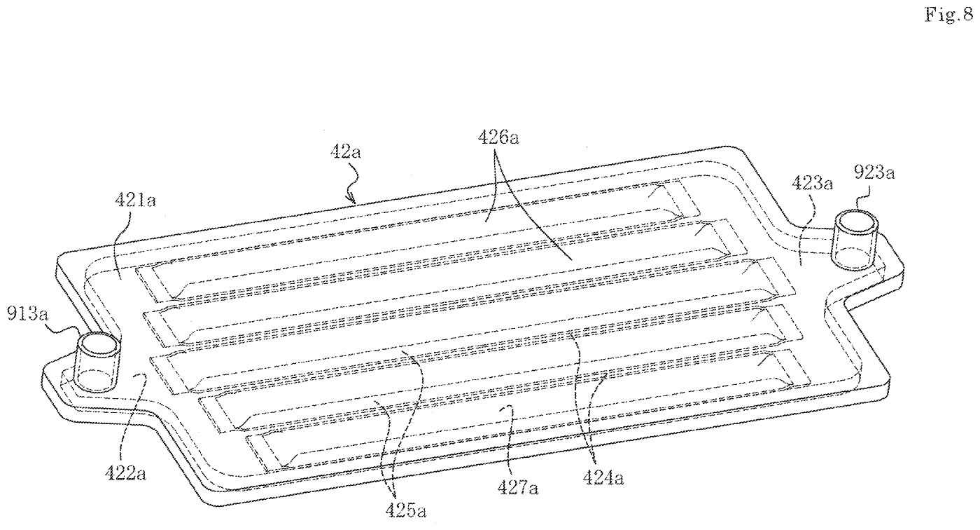

The configuration of the heat exchange panel in the battery heat exchange structure of the present invention can be appropriately configured within the scope of the present invention. For example, a heat exchange panel 42a of the modification in FIG. 8 may be used. The heat exchange panel 42a also has a substantially rectangular shape in a plan view, in which a heat exchange fluid such as the refrigerant F circulates. An inlet port 422a and a protruding pipe 913a through which the heat exchange fluid is introduced are provided at one end in the longitudinal direction of the heat exchange panel 42a, and an outlet port 423 and a protruding pipe 923a through which the heat exchange fluid is led out are provided at the other end. The heat exchange panel 42a is preferably provided with a heat exchange wall 421a formed of a flexible thin plate having a thickness of 0.5 mm or less, and the heat exchange panel 42a, the battery cell 41, and the like are closely arranged side by side so that the heat exchange wall 421a follows the side surface 411 and the like of the battery cell 41.

A flow path wall 425a defining a flow path 424a through which the heat exchange fluid circulates along the heat exchange wall 421a is provided in the heat exchange panel 42a. The flow path wall 425a is provided so as to be able to expand and contract in the erecting direction, that is, in the direction in which the heat exchange walls 421a face each other. In the heat exchange panel 42a of the illustrated example, the flow path wall 425a is composed of a bag-shaped elastic storage portion 426a fixed to the heat exchange wall 421a, and the configuration of the elastic storage portion 426a is the same as the elastic storage portion 426 of the above-described embodiment. Furthermore, in the heat exchange panel 42a of the illustrated example, the elastic storage portion 426a is filled with the latent heat storage material 427a that undergoes a phase change at a temperature lower than the temperature of the refrigerant when the refrigerant is supplied. It is preferable that the refrigerant F is used as the heat exchange fluid. Even if the heat exchange panel 42a of the modification is used, the same effect as the heat exchange panel 42 can be exhibited.

### INDUSTRIAL APPLICABILITY

The present invention can be used, for example, when performing heat exchange with respect to a battery of an electric vehicle or the like.

### REFERENCE SIGNS LIST

1 Insulating container
2 Insulating container main body
21 Inner wall
211 Bottom portion
212 Peripheral side portion
213 Flange
22 Outer wall
221 Bottom portion
222 Peripheral side portion
223 Flange
23 Container-side flat flange
24 Penetrating portion
3 Insulating lid
31 Inner lid
311 Substrate
312 Erected portion
313 Flange
32 Outer lid
33 Lid-side flat flange
4 Battery body
41 Battery cell
411 Side surface
42, 42a Heat exchange panel
421, 421a Heat exchange wall
422, 422a Inlet port
423, 423a Outlet port
424, 424a Flow path
424p, 424q, 424r Branch flow path
425, 425a Flow path wall
426, 426a Elastic storage portion
427, 427a Latent heat storage material
428 Fixing portion
51, 52 Holding plate
61, 71 Support stay
62, 72 Insulating material
63, 73 Bolt
81 Shaft bolt
82, 83, 84 Nut
85 Washer
86 Coil spring
91 Fluid supply pipe
911 Fluid lead-out pipe
912 Connecting pipe
913, 913a Protruding pipe
92 Fluid discharge pipe
921 Fluid lead-out pipe
922 Connecting pipe
923, 923a Protruding pipe
10 Cap
101 Insertion hole
100 Battery heat exchange structure
11 Temperature sensor
12 Refrigerant control unit
13 Refrigerant fluid storage unit
S1, S2, S3, S4 Insulating space
F Refrigerant

1-7. (canceled)

8. A battery heat exchange structure in which
a heat exchange panel and a battery cell are closely arranged side by side so that a heat exchange wall of the heat exchange panel in which a heat exchange fluid circulates follows a side surface of the battery cell, and
the heat exchange wall following the side surface of the battery cell is formed of a flexible thin plate.

9. The battery heat exchange structure according to claim 8, wherein
a flow path wall defining a flow path through which the heat exchange fluid circulates along the heat exchange wall is provided in the heat exchange panel, and
the flow path wall is provided so as to be able to expand and contract in an erecting direction.

10. The battery heat exchanger according to claim 9, wherein
the heat exchange fluid is a refrigerant, and
an elastic storage portion forming the flow path wall is filled with a latent heat storage material that undergoes a phase change at a temperature lower than the temperature of the refrigerant when the refrigerant is supplied.

11. The battery heat exchange structure according to claim 10, wherein
the flow path has three or more branch flow paths,
each of the branch flow paths is provided so as to circulate the refrigerant along the heat exchange wall, and
the latent heat storage material is provided at least between the branch flow paths.

17. The battery heat exchange structure according to claim 8, wherein
the heat exchange panel and the battery cell are elastically urged so as to be compressed in the arrangement direction.

13. The battery heat exchange structure according to claim 9, wherein
the heat exchange panel and the battery cell are elastically urged so as to be compressed in the arrangement direction.

14. The battery heat exchange structure according to claim 10, wherein
the heat exchange panel and the battery cell are elastically urged so as to be compressed in the arrangement direction.

15. The battery heat exchange structure according to claim 11, wherein
the heat exchange panel and the battery cell are elastically urged so as to be compressed in the arrangement direction.

16. The battery heat exchange structure according to claim 8, wherein
a battery body including the battery cell and the heat exchange panel, and a support portion supporting the battery body are housed in an insulating container.

17. The battery heat exchange structure according to claim 9, wherein
a battery body including the battery cell and the heat exchange panel, and a support portion supporting the battery body are housed in an insulating container.

18. The battery heat exchange structure according to claim 10, wherein
a battery body including the battery cell and the heat exchange panel, and a support portion supporting the battery body are housed in an insulating container.

19. The battery heat exchange structure according to claim 11, wherein
a battery body including the battery cell and the heat exchange panel, and a support portion supporting the battery body are housed in an insulating container.

20. The battery heat exchange structure according to claim 12, wherein
a battery body including the battery cell and the heat exchange panel, and a support portion supporting the battery body are housed in an insulating container.

21. The battery heat exchange structure according to claim 13, wherein
a battery body including the battery cell and the heat exchange panel, and a support portion supporting the battery body are housed in an insulating container.

2. The battery heat exchange structure according to claim 14, wherein
a battery body including the battery cell and the heat exchange panel, and a support portion supporting the battery body are housed in an insulating container.

23. The battery heat exchange structure according to claim 15, wherein
a battery body including the battery cell and the heat exchange panel, and a support portion supporting the battery body are housed in an insulating container.

24. The battery heat exchange structure according to claim 8, wherein
the heat exchange fluid is a refrigerant,
a temperature sensor for detecting a temperature of the battery cell is provided close to the battery cell, and
a refrigerant control nit supplies the refrigerant having a required temperature to the heat exchange panel according to a detection temperature from the temperature sensor.

25. The battery heat exchange structure according to claim 9, wherein
the heat exchange fluid is a refrigerant,
a temperature sensor for detecting a temperature of the battery cell is provided close to the battery cell, and
a refrigerant control unit supplies the refrigerant having a required temperature to the heat exchange panel according to a detection temperature from the temperature sensor.

26. The battery heat exchange structure according to claim 10, wherein
the heat exchange fluid is a refrigerant,
a temperature sensor for detecting a temperature of the battery cell is provided close to the battery cell, and
a refrigerant control unit supplies the refrigerant having a required temperature to the heat exchange panel according to a detection temperature from the temperature sensor.

27. The battery heat exchange structure according to claim 11, wherein
the heat exchange fluid is a refrigerant,
a temperature sensor for detecting a temperature of the battery cell is provided close to the battery cell, and
a refrigerant control unit supplies the refrigerant having a required temperature to the heat exchange panel according to a detection temperature from the temperature sensor.
